(19) United States
(12) Patent Application Publication
(10) Pub. No.: US 2017/0253130 A1
(43) Pub. Date: Sep. 7, 2017

(54) Device For Charging A Vehicle

(71) Applicant: Continental Automotive GmbH, Hannover (DE)

(72) Inventors: Stephan Bartz, Regensburg (DE); Peter Saeger, Friedrichsdorf (DE); Gerhard Lex, Neutraubling (DE)

(73) Assignee: Continental Automotive GmbH, Hannover (DE)

(21) Appl. No.: 15/509,787

(22) PCT Filed: Sep. 8, 2015
(86) PCT No.: PCT/EP2015/070523

§ 371 Date: Mar. 8, 2017

(30) Foreign Application Priority Data
Sep. 11, 2014 (DE) 10 2014 218 217.4

(51) Int. Cl. B60L 11/18; H02J 7/02

(52) U.S. Cl. CPC B60L 11/182; B60L 11/1824; H02J 7/025; B60L 2230/10

(57) ABSTRACT

The present disclosure relates to electric vehicles and the teachings thereof may be embodied in devices and methods for inductively charging an electric vehicle. A device for inductively charging a vehicle may include: a primary coil for transmitting electrical power via a transmission region to a secondary coil during a charging process; the secondary coil associated with a vehicle disposed above the primary coil; and a dome disposed above the primary coil for removing foreign bodies entering the transmission region.

### CROSS-REFERENCE TO RELATED APPLICATIONS

This application is a U.S. National Stage Application of International Application No. PCT/EP2015/070523 filed Sep. 8, 2015, which designates the United States of America, and claims priority to DE Application No. 10 2014 218 217.4 filed Sep. 11, 2014, the contents of which are hereby incorporated by reference in their entirety.

### TECHNICAL FIELD

The present disclosure relates to electric vehicles and the teachings thereof may be embodied in devices and methods for inductively charging an electric vehicle.

### BACKGROUND

Devices for charging electric vehicles may include well-known forms from the prior art, for example as induction charging devices for electrically operated vehicles. The devices may comprise a charging unit recessed into the ground with the primary coil to enable the electrical power transmission from the primary coil to the secondary coil with suitable positioning of a vehicle equipped with the secondary coil in the floor area of the vehicle. The transmission region extending between the primary coil and the secondary coil may be only the “air” between the ground and the floor of the vehicle.

During the charging process, an alternating magnetic field is produced by the primary coil, with which electrical energy is passed to the secondary coil of the vehicle in a known manner. During said transmission of often very high power (for example in the region of several kilowatts), there should be no foreign bodies in the transmission region. In one example, the high magnetic flux densities in the transmission region can result in ferromagnetic foreign bodies heating up in the field (energy loss and risk of fire). Moreover, for example living foreign bodies such as small animals that are in the transmission region during the charging process can suffer damage by the magnetic field or the associated heat generation.

With regard to this problem, measures for the detection of any foreign bodies in the region of an inductive charging device have already been proposed in the prior art, cf. for example DE 10 2012 213 958 A1 and DE 10 2012 215 376 A1. Such detection measures are indeed helpful, for example for a necessary warning to the user of the device, but still do not eliminate the actual problem, e.g., the basic risk that foreign bodies can enter the transmission region.

### SUMMARY

The teachings of the present disclosure may be employed to prevent any foreign bodies in the transmission region with a device of the aforementioned type. In some embodiments, a device (10) for inductively charging a vehicle (1) may comprise a primary coil (14) for transmitting electrical power from the primary coil (14) via a transmission region (18) to a secondary coil (5) during a charging process during which the secondary coil (5) of a vehicle (1) is disposed above the primary coil (14), chacterized in that a dome (30) covering the primary coil (14) is provided for keeping foreign bodies out of the transmission region (18) using gravity.

In some embodiments, the top surface of the dome has a friction-reducing coating and/or has a friction-reducing surface treatment.

Some embodiments may include means (40,16; 44,16) for mechanical shock stimulation and/or vibration stimulation of the surface of the dome (34). In some embodiments, magnetic flux conducting means (44) are provided in the dome (30).

### BRIEF DESCRIPTION OF THE DRAWINGS

The invention is described further below using exemplary embodiments with reference to the accompanying drawings. In the figures:

FIG. 1 shows a schematic side view to illustrate a known inductive charging device and the charging process on a vehicle implemented therewith,

FIG. 2 shows a schematic side view of an inductive charging device according to an exemplary embodiment,

FIG. 3 shows a top view of a dome that can be used with an inductive charging device according to a further exemplary embodiment,

FIG. 4 shows a top view of a dome according to a further exemplary embodiment,

FIG. 5 shows a top view of a dome according to a further exemplary embodiment,

FIG. 6 shows a schematic side view of an inductive charging device according to a further exemplary embodiment,

FIG. 7 shows a schematic side view of an inductive charging device according to a further exemplary embodiment, and

FIG. 8 shows a schematic side view of an inductive charging device according to a further exemplary embodiment.

### DETAILED DESCRIPTION

The teachings of the present disclosure may include providing a dome covering the primary coil to keep foreign bodies out of the transmission region using gravity. If, for example, the primary coil is disposed recessed into the ground, such as is currently envisaged as a concept for public car parks, then according to the invention the problem of the effect of foreign bodies can be minimized by a dome (for example a raised part of the structure above the primary coil). With a suitably strong slope (angle of inclination) of a surface of the dome (outer surface of the dome) towards the sides, it can be ensured for example by gravity alone that objects are removed from the transmission region or a particularly critical central part of the transmission region or magnetic field (by sideways directed sliding or rolling on the surface of the dome).

In addition to the nature of the surface, above all the shape of the surface of the dome is decisive for the operation of the dome. There are various possibilities for the specific shape of the surface of the dome. Some embodiments may include a slope driving force directed towards a lateral edge of the dome for objects disposed on the dome. An overall curved, for example approximately spherically curved, surface of the dome is conceivable for example. Such an embodiment, however, may have a relatively small angle of inclination relative to the horizontal in the area about an upper apex of the dome.

In some embodiments, a surface of the dome is provided that has an angle of inclination of at least 20° at all points when viewed from an upper apex or an upper ridge line.

In some embodiments, the vertical projection of the surface of the dome, the “footprint” of the dome, is circular, oval or polygonal (in particular a regular polygon). A polygonal shape can for example be rectangular (for example square) or for example hexagonal (for example a regular hexagon).

The dome may be disposed centered in the lateral direction relative to a vertical center line of the primary coil. In particular, if the primary coil comprises an at least approximately horizontally orientated coil plane and an at least approximately circular shape, it is therefore useful if the dome is rotationally symmetrical about a vertical center line or the primary coil axis or at least “approximately rotationally symmetrical” to a vertical center line (or coil axis). The latter can for example be achieved by a pyramid shape with for example five, six, seven, or eight order rotational symmetry.

The surface of the dome may be no higher at any point than in the region of the surface of the dome that is disposed in a “center” of the transmission region when viewed laterally where the magnetic field strength may be particularly great.

In some embodiments, the surface of the dome does not extend downwards below ground level.

In some embodiments, the vertical projection of the surface of the dome (in terms of area) is the same size or larger than the vertical projection of the primary coil and that the last-mentioned projection lies fully within (preferably centered within) the first-mentioned projection.

It is ensured thereby that on the one hand the dome is effective for keeping foreign bodies out of a region that is relatively large when viewed laterally (larger than the primary coil area). The projection of the surface of the dome can for example be greater by at least a factor of 2 than the projection of the primary coil. On the other hand, it is thereby ensured that the dome is effective for keeping foreign bodies primarily out of a particularly critical region (with relatively high magnetic field strength).

The devices described may be operated in a special operating mode for discharging the vehicle. The vehicle to be charged (or discharged) may be an electric vehicle, which comprises an electrical energy storage device and is exclusively driven by means of electrical energy, or for example a hybrid vehicle with at least partial provision of drive energy in the form of electrical energy from an energy storage device within the vehicle.

The dome can be implemented in a solid form. Alternatively, an at least partly hollow implementation is considered. An internal space of the dome can be used entirely or partly as installation space for installed equipment. For example, the primary coil can be completely or partly disposed within the extent of the dome, e.g., in the interior of the dome. In some embodiments, the surface of the dome extends entirely over the primary coil. This is for example the case if a primary coil that is recessed into the ground is covered by a dome that is disposed on the ground or above the ground.

Alternatively, the surface of the dome may extend only partly over the primary coil. If a dome that is disposed on the ground or above the ground is provided, the vertical extent of the primary coil may lie wholly or partly within the vertical extent of the dome.

In some embodiments, the top surface of the dome has a friction-reducing coating and/or has a friction-reducing surface treatment. The desired effect of objects sliding off can be promoted by such measures. The dome surface can thus for example be formed by a layer of a material that is additionally applied to the top surface of the dome or a dome casing (for example a suitable metal alloy), which is different from the underlying dome material and thus in particular can guarantee a relatively low coefficient of friction of the surface of the dome. The surface treatment that can be provided alternatively or additionally can for example comprise polishing.

Some embodiments may include means for mechanical shock stimulation and/or vibration stimulation of the surface of the dome are provided. These embodiments may include a hollow dome because in general such a dome can be deflected or stimulated to vibrate more energy efficiently. Foreign bodies remaining on the surface of the dome despite tilting can be induced to slide or roll by shocks or vibrations.

In some embodiments, the device includes an acoustic transmitter for deterring animals. One such transmitter (for example “pest repeller”, etc.) may be integrated as an installed component within the internal space of the dome. Alternatively or additionally, such an acoustic transmitter can also be implemented as special functionality or a special operating mode of the aforementioned means for mechanical shock and vibration stimulation. In the latter case, a dome surface or dome casing can be additionally used as is well known as a “loudspeaker membrane”.

The greater the height of the dome, the more slope may be used to eliminate foreign bodies, so the height should generally be as great as possible. Nonetheless, it is limited by the construction (for example “ground clearance”) of the vehicle to be charged or the arrangement thereof during the charging process. In general, a height of the dome relative to ground level may be approximately 70% to 90% of the minimum “ground clearance” that is to be expected when driving vehicles over or positioning vehicles. Increased height of the dome not only brings advantages for the elimination of foreign bodies (for example greater inclination of the surface of the dome for a given dome footprint), but also as already mentioned to provide installation space for components of the device or devices installed in the dome.

In some embodiments, magnetic flux conducting means are provided in the dome. Thus for example, ferrite or other magnetically conductive (ferromagnetic) materials can be introduced into the dome in order thereby to conduct the “transmission field” emitted by the primary coil during the charging process in the desired manner, and in particular to focus it towards the secondary coil. With magnetic flux conducting means, the dimensions of a stray field that degrades the energy transmission efficiency, which otherwise exists because of the relatively large air gap, can thereby be advantageously reduced. The material may comprise blocks or rods (for example one or more ferrite blocks or ferrite rods) in the internal space of the dome. When viewed vertically, such magnetically conductive material can extend for example over at least a large portion of the region between the plane of the primary coil and the highest point of the surface of the dome.

In addition, the material of a solid dome or the material of a dome casing (in the case of a hollow dome implementation) can be suitably selected or modified in this respect. With a dome casing of a magnetically non-conductive basic material (for example metallic or plastic), for example a magnetically conductive material in the form of powder or particles can be integrated within the dome or in a dome casing (e.g., concentrated in the region about a central vertical center line of the dome).

The embodiments described may significantly reduce the influence or the dwell period of foreign bodies in the transmission region of the device. Because the invention utilizes gravity, it may provide a particularly simple, inexpensive and reliable measure (“passive protection”) to keep foreign bodies rolling under the vehicle, or even living foreign bodies, away at least from the particularly critical part of the magnetic field as far as possible.

Additional detection measures for the detection of foreign bodies can be used within the scope of the invention. Regarding the sensor arrangement required, the internal space of a hollow dome can be used. For example, one or more sensors for detecting foreign bodies can be disposed in the dome.

Furthermore, the dome may simplify the reliable positioning of the vehicle for the charging process. Whereas for example a colored ground marking only over a primary coil that is recessed into the ground can easily be covered with leaves or similar and thereby be hard for a driver to recognize, such a problem does not arise so easily with a dome as described herein. The dome may be more visually prominent. Furthermore, the dome may be on a base, which may have a larger extent than the dome itself when viewed laterally for example, and in this case can act as a type of guide to the correct vehicle position for a driver.

The dome, and the casing thereof, can be of a folding design. An actuator can be used to erect the dome. The actuator can be an electromechanical drive that engages within the dome. Furthermore, the actuator can be electropneumatic to produce an overpressure in the dome by means of which the dome is erected. In this case, the dome may comprise a bellows that is foldable and/or elastic. In the case of an electropneumatic drive, the dome may be closed fluid tight (so that the pressure can increase). The actuator is may be activated before charging, and in particular if the vehicle is stationary or the charging control unit determines that the drive of the vehicle is turned off. The charging control unit can be connected to the actuator for control purposes to control the actuator to erect the dome before the charging process starts. At the end of the charging process or before or during activation of the drive, the dome may be folded up again (mechanically or pneumatically by ending the overpressure).

In connection with foreign body detection measures, these embodiments may reduce the risk or the duration of charging interruptions by foreign bodies. Moreover, they may contribute to the efficiency of energy transmission. The teachings of the present disclosure may provide simple, inexpensive, and low wear solutions.

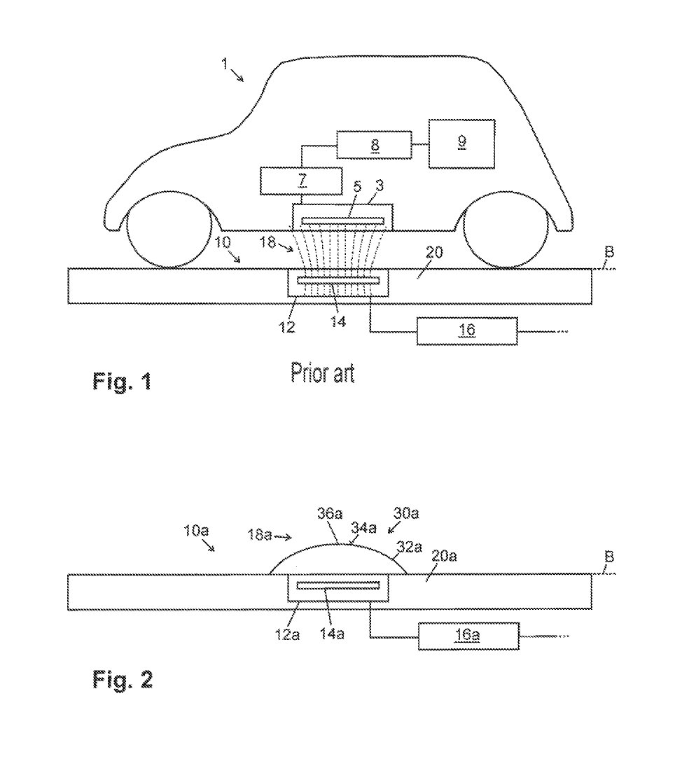

FIG. 1 shows an inductive charging device 10 for inductively charging a vehicle 1, comprising a charging unit 12 containing a primary coil 14. For charging the vehicle 1, e.g., an electric vehicle, a hybrid vehicle, or similar, said vehicle is first parked in the region of the device 10 as illustrated in FIG. 1. A secondary coil 5 in a charging unit 3 of the vehicle 1 passes to a suitable position relative to the primary coil 14. In the example, the secondary coil 5 is for example disposed approximately coaxially above the primary coil 14. Using suitable control by a charging control unit 16 on the device side (and supplied with electrical energy), electrical power can then be transmitted in a known manner from the primary coil 14 via a transmission region 18 to the secondary coil 5.

Shown dashed in FIG. 1 are field lines of the alternating magnetic field produced by the primary coil 14, which induces an alternating voltage in the secondary coil 5, which is delivered to an electrical wiring system 8 containing inter alia an electrical energy storage device after rectification by a charging control unit 7 on the vehicle side. The energy originating from the wiring system 8 or the energy storage device disposed therein can be used for example during operation of the vehicle 1 for supplying a driving device 9 of the vehicle 1.

In the example shown, the charging unit 12 is recessed into the ground or in a base that 20 can be driven on and that is recessed into the ground. The ground level is characterized by B. If foreign bodies can pass into the region of the device 10 they may increase risk. If, for example, foreign bodies consisting of or containing ferromagnetic material are disposed within the transmission region 18 during an energy transmission process, in particular on or at a short distance from the common vertical axis of the coils 14, 5, then said foreign bodies can be strongly heated by eddy current effects. This not only adversely affects the efficiency of the inductive energy transmission, but can also cause a risk of fire, for example.

Furthermore, living foreign bodies (for example small animals) that are within the magnetic field during the charging process are also at risk as such. Various exemplary embodiments of inductive charging devices are described below with reference to FIGS. 2 through 8, in which the potential risk described above is considerably reduced.

The exemplary embodiments described below comprise a dome covering the primary coil for keeping foreign bodies out of the transmission region taking advantage of the effects of gravity. In the following description of further exemplary embodiments, the same reference numbers are used for components with an equivalent effect, supplemented in each case by a small letter for distinguishing the embodiment. In doing so, the difference from the already described exemplary embodiments is described and for the rest express reference is made to the description of previous exemplary embodiments.

FIG. 2 shows an inductive charging device 10a comprising a primary coil 14a as well as a dome 30a covering the primary coil 14a. The dome 30a can be implemented in a solid or hollow form (for example only consisting of a dome casing 32a) and comprises an at least approximately spherical dome surface 34a in the example shown.

The surface of the dome 34a extends horizontally only at an apex 36a, which is disposed for example approximately 10 to 15 cm above the ground level B in the example shown. However, at all other points the surface of the dome 34a has a greater or smaller inclination relative to the horizontal. In the example shown of a spherical surface of the dome 34a, said angle of inclination increases steadily starting from the apex 36a and as a function of a radial distance from the vertical center line of the dome 30a, and reaches a value of approximately 45° at the edge of the dome.

With the dome 30a, during a charging process (cf. FIG. 1) any foreign bodies are kept away from the dome 30a or roll or slide off said dome 30a. Foreign bodies are thereby in particular kept away from the region with particularly high magnetic flux density (near the vertical center line of the dome 30a).

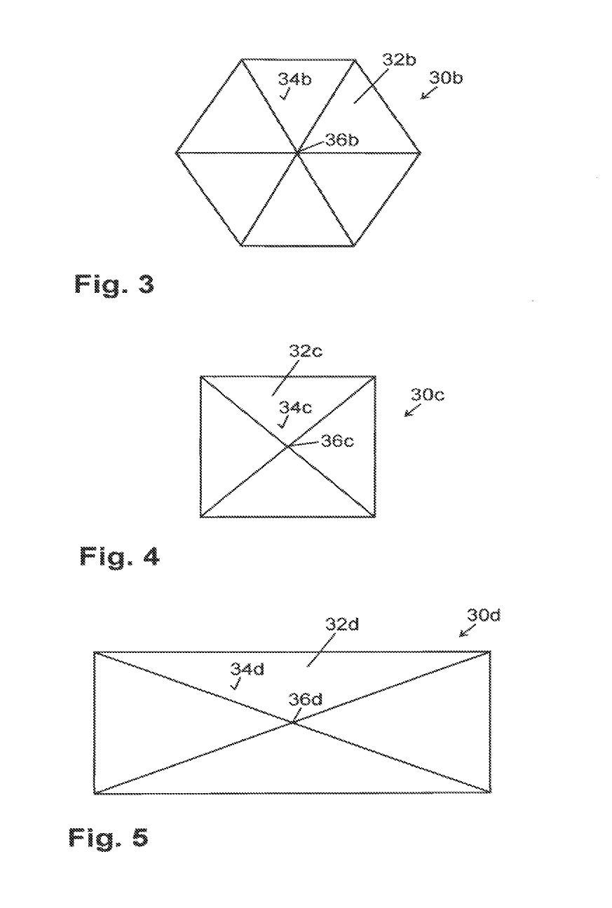

There are various possibilities for the specific shape of the surface of the dome. Alternative dome surfaces, which can be provided for example with the dome 30a of FIG. 2 or the further exemplary embodiments yet to be described below, are described below with reference to FIGS. 3 through 5 only by way of example.

FIG. 3 shows a dome 30b with a pyramid-shaped dome surface 34b. A vertical projection of the surface of the dome 34b is hexagonal, in this case a regular hexagon. Accordingly, the surface of the dome 34b is composed of six respectively planar triangular surface segments of a dome casing 32b.

FIG. 4 shows a dome 30c with a likewise pyramid-shaped dome surface 34c, the vertical projection of which is however square, so that the surface of the dome 34c is composed in this case of four respectively planar triangular surface segments of a dome casing 32c.

FIG. 5 shows a dome 30d with a likewise pyramid-shaped dome surface 34d, the vertical projection of which is elongated rectangular.

An advantage of the shapes shown in FIGS. 3 through 5 is that the respective surface of the dome at all points, apart from a small apex region, has an angle of inclination relative to the horizontal that is appreciably different from zero (the surface segments of the dome surface mentioned do not necessarily have to be planar for this, however).

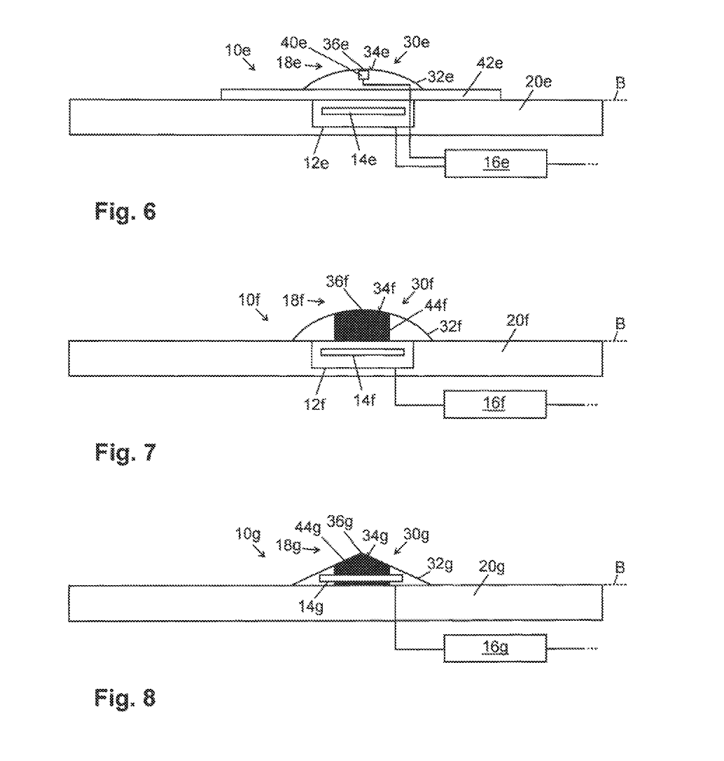

FIG. 6 shows a device 10e according to a further exemplary embodiment. A device 40e for shock and/or vibration stimulation of the hollow implemented dome 30e is additionally provided. In the example shown, the device 40e is disposed in an internal space of the dome 30e to act on a dome casing 32e from the inside. The device 40e can for example be electrically operated as shown and controlled by a charging control unit 16e. For example, the charging control unit 16e can cause such stimulation before the start of each energy transmission process and/or at regular intervals during each charging process.

The device 40e may comprise an acoustic transmitter, for example such as a “pest repeller” or similar. Alternatively, such an acoustic transmitter can also be provided separately in this or another of the exemplary embodiments, and can be disposed in the internal space or on the outside of the dome involved, for example.

Moreover, FIG. 6 shows the dome 30e on a base 42e that extends beyond the lateral edges of the dome 30e in at least one lateral direction (for example in the left-right direction as can be seen in FIG. 6). The base 40e can for example comprise a rectangular contour and acts as a type of “guide” for a driver of a vehicle to be charged to the correct position of the vehicle for a charging process, be it as a “visually detectable” guide for the driver and/or as a “mechanical” guide of the vehicle, for example on the inner sides of the vehicle wheels.

FIG. 7 shows a device 10f according to a further exemplary embodiment. A dome 30f of the device 10f contains magnetic flux conducting means in order therewith to advantageously cause focusing of the magnetic flux in a transmission region 18f. In the example shown, said means comprise a ferrite core 44f extending coaxially to a primary coil 14f in the interior of the dome 30f. The ferrite core 44f comprises a circular cross-section in the example shown (at least in the lower region). The cross-section of the ferrite core 44f may be approximately the same size as the cross-section of the primary coil 14f, or (as shown) smaller than the cross-section of the primary coil 14f. The top of the ferrite core 44f can hereby form part of a surface of the dome 34f (or can end below/on a dome casing 32f).

With a suitable implementation, magnetic flux conducting means even advantageously enable an additional use as a device for producing shocks and/or vibrations, namely by stimulation, such as by means of the magnetic field that can be produced by the primary coil 14f. For this purpose, for example a somewhat modified (for example not wholly “eddy current-free”) ferrite core 44f can be solidly joined at the upper end thereof to the “vibrational” dome 30 or dome casing 32 (for example glued), whereas the ferrite core 44f is supported sufficiently elastically on the lower end thereof or not at all to transfer a magnetic field-induced vibration stimulation of the ferrite core 44f to the surface of the dome.

Alternatively, for producing shocks and/or vibrations by means of a magnetic field that can be produced by the primary coil 14f, for example an electromagnet or a permanent magnet can be disposed and supported in the interior of the dome so that said magnet is stimulated to shocks or vibrations by the magnetic field and said shocks or vibrations are transmitted to the dome casing 32f.

FIG. 8 shows a device 10g according to a further exemplary embodiment, in which likewise a ferrite core 44g for conducting magnetic flux is disposed in an internal dome space of a dome 30g. However, in contrast to the device 10f, a pyramid-shaped dome surface 34g is provided in the device 10g. No charging unit for accommodating a primary coil is provided recessed into the ground below ground level B with the device 10g, but a primary coil 14g is introduced into an internal space of the dome 30g.

In the common arrangement shown of the primary coil 14g and the ferrite core 44g in the interior of the dome, the ferrite core 44g passes through the plane of the primary coil 14g in the vertical direction. In the example shown, the ferrite core 44g extends from an apex 36g of the dome 30g downwards to the ground level B.

With all the previously described exemplary embodiments, the surface of the dome can be coated to improve the effectiveness thereof (for example with a material of a relatively low coefficient of friction compared to metallic materials).

Alternatively or additionally, the surface of the dome can be surface treated (for example polished).

What is claimed is:

1. A device for inductively charging a vehicle, the device comprising:
a primary coil for transmitting electrical power via a transmission region to a secondary coil during a charging process;
the secondary coil associated with a vehicle disposed above the primary coil; and
a dome disposed above the primary coil for removing foreign bodies entering the transmission region.

2. The device as claimed in claim 1, wherein a top surface of the dome has a friction-reducing coating or has a friction-reducing surface treatment.

3. The device as claimed in claim 1, further comprising mechanical shock stimulation or vibration stimulation of the dome.

4. The device as claimed in claim 1, further comprising magnetic flux conductors disposed in the dome.
